(19) United States
(12) Patent Application Publication
(10) Pub. No.: US 2026/0028780 A1
(43) Pub. Date: Jan. 29, 2026

(54) METHOD FOR MANUFACTURING A DEVICE FOR A MASTER FORMING PROCESS, DEVICE FOR A MASTER FORMING PROCESS AND MASTER FORMING PROCESS

(71) Applicant: Università della Svizzera italiana, Lugano (CH)

(72) Inventors: Ena LLORET-FRITSCHI, Lugano (CH); Fabio AMICARELLI, Lugano (CH); Selen ERCAN JENNY, Lugano (CH); Tsai PING-HSUN, Lugano (CH); Daniele Angelo BRUNO, Lugano (CH)

(73) Assignee: Università della Svizzera italiana, Lugano (CH)

(21) Appl. No.: 19/350,481

(22) Filed: Oct. 6, 2025

Related U.S. Application Data
(63) Continuation of application No. PCT/EP2024/059239, filed on Apr. 4, 2024.

(30) Foreign Application Priority Data
Apr. 5, 2023 (EP) 23166714.8

(51) Int. Cl. D21J 5/00; B28B 7/34

(52) U.S. Cl. CPC D21J 5/00; B28B 7/346

(57) ABSTRACT

A method for manufacturing a device for a master forming process and a master forming process. In the method for manufacturing a device for a master forming process a flat initial semi-finished product is provided and this initial semi-finished product is deformed in a bending process such that the initial semi-finished product is given a three-dimensional structure as a negative mould on one side via a plurality of partial surfaces running in different planes. The plurality of partial surfaces are configured to delimit a component produced via a master forming process using the device on one side in the master forming process. A supporting structure is provided and the negative mould is arranged at or on or around the supporting structure such that the negative mould and an amorphous material to be arranged thereon is supported or supportable by the supporting structure in the master forming process.

This nonprovisional application is a continuation of International Application No. PCT/EP2024/059239, which was filed on Apr. 4, 2024, and which claims priority to European Patent Application No. 23166714.8, which was filed on Apr. 5, 2023, and which are both herein incorporated by reference.

### BACKGROUND OF THE INVENTION

### Field of the Invention

The present invention relates to a method for manufacturing a device for a master forming process, and to the corresponding device for the master forming process. Further, the invention relates to the master forming process.

### Description of the Background Art

The construction industry is responsible for 50% of global gas emissions and 30% of waste material generated worldwide every year. The largest part of the built environment relies on concrete, which produces 7% of global CO2 emissions. Although several realized construction projects show that load-bearing structures can be built using significantly less material, most structures are still built in a non-optimized way. This is due to the high cost of formworks, which represent up to 60% of the overall cost of a standard structure, rising to 80% or more for non-standard structures. In addition to this, timber formworks are one of the most waste-generating components in traditional construction processes. Today the most common formwork system for concrete structures are formed of reusable shutters made of wood or metal, which is significantly wasteful in terms of both bulk and formwork material.

In the construction industry, formworks or negative moulds, are also used for producing building elements with non-standard and/or non-repetitive geometries in master forming processes. These mould structures, into which a variety of materials can be casted or sprayed to produce the building element, often are built from thick materials and therefore expensive to produce, time consuming and waste generating.

Some more efficient technologies available on the market use void fillers placed inside the formwork to save mass material and lighten the structure, such as in ribbed or waffle slabs, and hollow core slabs. With the rapid development of digital technologies, flexible formwork systems are introduced to the market, which allow the realization of single and double curved geometries. Several novel approaches were also developed in academic research, such as fabric formworks, automatic changing slipformwork formworks, filament extruded formworks and stay-in-place formworks for instance made of steel or textiles.

In WO2013192141, which corresponds to US 2015/0191921, a modular void form is described. The modular void form can include a panel and at least one reinforcement member. The panel can include one or more scoring lines which the panel can be folded about. When the panel is folded, a tubular structure having a flange can be formed. The panel can include a plurality of slits that form slots when the panel is folded. The reinforcement members can be adapted to be removably inserted into the slots of the panel and engage the flange of the folded panel.

US 2005/0011152 A1 discloses a cavity former for use in forming a cavity in a concrete slab. The cavity former comprises a support member which supports the weight of a person standing on the cavity former, or of wet concrete bearing down on the array until the concrete has cured sufficiently to support itself. The array is reconfigurable between a compact state for stacking with other similarly configured arrays to facilitate transport and an expanded state to define a volume about which the wet concrete is poured. The cavity former has a cover which is engageable with the array to distribute the weight onto the array elements and prevent wet concrete flowing into the volume defined by the elements in the expanded state.

FR3077832A1 describes a reservation box for a floor, said floor being constituted by at least one factory prefabricated slab called pre-slab, which is associated with a slab cast on site, called compression slab, said reservation box comprising a box body provided with side walls, which comprise at least one intermediate folding line allowing to separate each side wall into a first part and a second part, in order to define a first folding configuration of said box body arranged to create a first reservation in said pre-slab, and a second folding configuration of said box body arranged to create a second reservation in said compression slab superimposed on the first reservation, and to form a floor with a through reservation.

In FR2991704A1 an opening mould is intended to form a cavity in a wall of cast concrete. The opening mould according to the invention comprises a central grid formed by central slats provided with a series of transverse notches arranged at a regular pitch, the central slats are criss-crossed at their notches and a frame formed by a blank in which transverse groove lines are formed, which delimit plane segments that encircle the central grid.

What all these foldable structures have in common is that their sides, which are in contact with a cast or sprayed material, cannot be generalized to adopt complex and/or miscellaneous shapes. Consequently, master moulding processes carried out with corresponding devices are not capable to produce elements with non-standard and/or non-repetitive geometries, for instance custom or bespoke geometries. In contrast, conventional devices used for master moulding processes, with which complex geometries can be realized, are expensive, waste generating and time consuming to manufacture.

### SUMMARY OF THE INVENTION

It is therefore an object of the present invention to provide a method for manufacturing a device for a master forming process, a device for the master forming process, and a master forming process, which enable a cost-saving and resource-saving production of master forming parts.

A first aspect of the invention relates to a method for manufacturing a device for a master forming process. In this method a flat initial semi-finished product is provided, and this initial semi-finished product is deformed in a bending process in such a way that the initial semi-finished product is given a three-dimensional structure as a negative mould on one side via a plurality of partial surfaces running in different planes. The plurality of partial surfaces are configured to delimit a component produced via a master forming process using a device on one side in the master forming process.

Further, in the method for manufacturing a device for a master forming process, a supporting structure can be provided and the negative mould can be arranged at or on the supporting structure. This is done in such a way that the negative mould and an amorphous material to be arranged thereon and/or a at least one person is supported or supportable by the supporting structure in the master forming process. In an example of the method for manufacturing a device for a master forming process, the initial semi-finished product is bent in such a way that it forms a closed cavity, wherein inside the cavity the supporting structure is provided.

The flat initial semi-finished product can be an essentially two-dimensional primary material whose thickness is at most 1/10 of its longest spatial dimension. The primary material of the initial semi-finished product can be folded, bent or draped into a three-dimensional geometry, in order to add structural properties to the semi-finished product. The side formed with the plurality of partial surfaces which are running at an angle to each other can be an outer side, or also an inner side of an at least partially hollow or concave shaped body of the component to be produced. A side of a component is defined in that it runs in a plane that has an angle of at most 120° to a plane in which an adjacent side or side surface is arranged. The plurality of partial surfaces can be regarded as parts of an ideal total surface that corresponds to a projection surface of the component. It is also possible to create more than two partial surfaces running in different planes. The method can be carried out in such a way that the partial surfaces are formed such that they delimit the component to be produced via a master forming process on only one side.

Due to use of a flat initial semi-finished product, bending this product also leads to a three-dimensional structure on the opposite side.

Further, it is not excluded by the present invention that the initial semi-finished product is given a three-dimensional structure as a negative mould on more than one sides.

Furthermore, the bent initial semi-finished product or the negative mould can be combined with a casing, so that the negative mould and the casing together provide the device.

However, the invention is not restricted to the use of a casing, instead the negative mould can be used without the casing, or the elements of the negative mould can be held together by a hoop tension bend, cable or strip.

For example, the negative mould may be merely placed on the supporting structure. The supporting structure may have the function of sustaining the weight of the cast or sprayed amorphous material. Such structure can be built using several approaches, like shaping solid materials such as sand, earth, foam, textile, expanded polystyrene, sheets of expanded polystyrene, honeycomb cardboard, wooden sheets panels, cardboard plates of any kind, 3D printing a supporting structure or creating a supporting grid from flat materials such as cardboard, wood, PET or metal. In the case of amorphous or grain-like materials, the supporting structure can be formed with a CNC device and, if needed, kept in place by using spray or liquids that can stiffen the material.

When the initial semi-finished product is bent in such a way that it forms a closed cavity, wherein inside the cavity the supporting structure is provided, box like negative moulds are provided, which may be used as voids or filler in the shape of columns, walls or slabs.

Alternatively, when casting or spraying large elements such as slabs, columns or walls, the three-dimensional structure given to the initial semi-finished product forming the negative mould can also be supported not only by one supporting structure but by several inlays. Inlays comprise three-dimensional structures. Such an inlay may include a supporting structure. In that case, the inlay forms a housing of the supporting structure. When using a plurality of inlays, the inlays may be positioned in a casing and the negative mould may arranged at or on the inlays. The inlays can also be used as void fillers and reused several times.

In examples of the method for manufacturing a device for a master forming process, the initial semi-finished product can be folded to realize the plurality of partial surfaces. This means that the bending process can be realized in such a way that the bending is carried out along folding edges, which causes a deformation along the folding edges. This way, the method can produce complex formworks from folded materials, for instance from ultra-thin folded materials.

Alternatively, or additionally, a draping of the initial semi-finished product may take place.

The initial semi-finished product may be formed at least partially of paper or cardboard. The paper or cardboard may be ultra-thin materials.

The cardboard can be made of corrugated cardboard.

Further, the semi-finished product can be made of materials such as PET or metal sheets, thin wooden panels, all types of textiles and impregnated textiles. If necessary, fibre and/or fibre reinforced materials can be used to reinforce the structure of the device. Furthermore, different coatings can be realized, for example, coatings with hydrophobic properties such as wax, silicon, polyethylene, anti-adherent spray or liquids. No supporting structure is necessary if the bending strength of the negative mould is sufficiently large that it does not deform impermissibly far under load of the amorphous material used in the master forming process.

The negative mould with the three-dimensional structure can be provided with a hydrophobic insert on at least one side.

This hydrophobic inlay can be a layer from a hydrophobic material, and can be provided on the bent or folded initial semi-finished product on the side where the master forming process can take place. After single use of the hydrophobic inlay it can be discarded or recycled, while the negative mould can be reused multiple times.

In an example of the method for manufacturing a device for a master forming process, the device can be formed by positioning the negative mould at or in the supporting structure, which is spatially delimited by a housing of the supporting structure.

Further, a system of devices can be formed by combining multiple devices. The devices can be positioned adjacent to each other in such a way that the receiving spaces of the devices adjoin each other and form one big receiving space to receive the amorphous material cast or sprayed inside. The devices can but don't have to, be placed in a casing. If horizontally placed, the system of devices creates a negative mould for horizontally cast elements, such as façade elements, bricks, tiles, or slabs. If vertically placed, they can be used to cast vertical structures like walls or columns.

The system of devices may comprise a common support structure supporting several negative moulds adjacent to each other, and/or a common casing.

In an example of the method for manufacturing a device for a master forming process it is foreseen that the supporting structure is manufactured by mechanical connections of supporting structure elements in a grid shape. In this approach, the grid elements can be computationally designed and digitally cut according to the resulting geometry of the final element. This way, the negative mould can be placed above the grid and held in its final shape even under high mechanical load. A wide range of materials can then be casted or sprayed inside the negative mould, including concrete, gypsum, clay, lime or cement-based plaster, clay-based mixes or earthen materials as well as porcelain materials.

In an example, the mechanical connections of the supporting structure elements can be realized via plug-in connections. For instance, the supporting grid elements may be produced with comb joints, allowing them to be easily assembled with 90° angles. According to the size of the negative mould and the weight of the cast and/or sprayed material above, the supporting grid structure can have different number of elements and densities of elements.

Alternatively, the supporting structure can be manufactured also by shaping solid or grain-like materials, or by 3D printing a supporting structure.

An an example of the method for manufacturing a device for a master forming process is characterized in that the geometric dimensions of a computer model of the component to be manufactured are used to realize an at least partially automated bending process for manufacturing the plurality of partial surfaces. In addition to the determination of the geometric data of at least one of the plurality of partial surfaces of the component to be manufactured, data can be generated for the purpose of setting up an at least partially automated process for bending the initial semi-finished product. Furthermore, the data can also be used to carry out at least partially automated trimming operations on the semi-finished product. Starting from a non-standard and/or non-repetitive geometry as input, a custom-made software generates the folding pattern for the fabrication of negative mould. The folding pattern is sent as a file to a CNC machine, which cuts and/or creases the primary material of the semi-finished product. It then can be folded, assembled and placed into a rigid frame to produce the device. The device can then be used in the master forming process or also before it can be sprayed with a fibre reinforced material, which creates a thin layer that is then used as the final element or as a stay-in-place negative mould. After the hardening time, the component is demoulded, while the device can be reused multiple times or recycled. In another case, the component can be left on the final element, defining its finishing surface. The geometry of the produced component can be scanned and input back into the software, where it is compared and validated against the original digital model. The circular life of the device is starting from the design, passing through to the construction, demoulding and finally recycling of the material used for the device or the negative mould.

Furthermore, a device for a master forming process is provided, which has been manufactured in the described way. It comprises the functionality to be used in a master forming process and can sustain a casted or sprayed amorphous material. The device can be part of a one-sided boundary of a moulding, or an insert or void filler. The negative mould of the device presents non-standard geometries and can be placed inside a rigid frame to form the cast or sprayed amorphous material.

The negative mould works as an intermediate layer between the cast or sprayed amorphous material and a possible underlaying supporting structure, creating a hydrophobic and anti-adherent layer. During the demoulding, it can be easily peeled off, defining the finishing of the final element.

The partial surfaces forming the three-dimensional structure may run between two mutually parallel ideal planes. The ratio between the distance of the planes D and the maximum projection area A max of the formed initial semi-finished product or the negative mould satisfies the condition: A max/D>10 mm. In the examples, it is provided that the following ratio is satisfied: A max/D>15 mm or A max/D>20 mm. This means that the two ideal planes, between which the partial surfaces run, are arranged very close to each other in relation to the size of the formed initial semi-finished product or its extension.

The three-dimensional structure can have a plurality of local maxima. A local area in which a maximum is defined extends to a turning point or to the edge of the formed initial semi-finished product or the negative mould.

An example of the device for a master forming process can be characterized in that the surface of the three-dimensional structure comprises a non-linear profile in all three spatial planes. This means that the surface of the three-dimensional structure in the xy-plane, in the xz-plane and in the yz-plane has a non-linear shape.

The device for a master forming process can further can comprise a casing which, together with the negative mould, delimits a receiving space for receiving the amorphous material at least in some areas. The casing may be a rigid frame made of different materials, such as wood, cardboard, metal, plastic or polystyrene, or a hoop tension cable, bend or strip that holds the negative mould in place. Inside the frame, the negative mould is placed. The casing can also be a structure with the function of containing vertical and/or horizontal pressure of the amorphous material on the negative mould.

Furthermore, a process for master forming a component can be provided in which a device as described above is provided and an amorphous material is applied to or on the negative mould so that a component having a side bounded and shaped by the negative mould and partial surfaces thereof is built up at or on the negative mould. After solidification of the amorphous material, demoulding of the produced component from the negative mould is carried out. The amorphous material can be for example initial materials in liquid, gaseous, ductile, granular or powdery state. For this process there are several castable materials available on the market, particularly concrete.

If the negative mould forms a cavity, the amorphous material may be applied inside of the negative mould.

Also, concrete, gypsum, clay, lime or cement-based plaster, clay-based mixes or earthen materials as well as porcelain materials may be used for casting or spraying.

The solidification of the amorphous material can also be understood as hardening. A side of a component is defined by the fact that it runs in a plane which has an angle of at most 120° to a plane in which an adjacent side or side surface is located. The process can be used to respectively produce vertical building elements such as walls and columns, or horizontal ones like slabs, facade elements, tiles or bricks. Here, the negative mould may be placed in horizontal or vertical direction.

An at least partially hollow or concave shaped body of the component can be produced by the side formed with the plurality of partial surfaces of the negative mould.

An example of the process for master forming a component is characterized in that the master forming process can be a casting process, a spraying process and/or a coating process.

The formwork can be used to cast a full structure or a part of a structure, or for spraying of a temporary form or full form.

A full structure can be for instance a staircase element or a balcony element.

The negative mould may be provided in a horizontal orientation, for instance in the case of using a mouldable material like sand or earth underneath.

The lightweight and transportable master mould provided by the invention, allows an easy assembling, casting and demoulding in a factory or on a construction site, while providing a high surface quality to the final element.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of the steps of the method for manufacturing a device for a master forming process and the steps of the master forming process.

FIG. 2 shows a perspective view of the device for a master forming process and the component to be produced therewith.

FIG. 3 shows a perspective view of the supporting structure.

FIG. 4 shows a perspective view of an example of a component produced with the device in the master forming process.

FIG. 5 shows a top view of the example of a component produced with the device in the master forming process.

FIG. 6 shows a perspective view of an example of a component produced with the device in the master forming process.

FIG. 7 shows a top view of the example of a component produced with the device in the master forming process.

FIG. 8 shows a perspective view of an example of a component produced with the device in the master forming process.

FIG. 9 shows a top view of the example of a component produced with the device in the master forming process.

FIG. 10 shows a perspective view of an example of a component produced with the device in the master forming process.

FIG. 11 shows a top view of the example of a component produced with the device in the master forming process.

FIG. 12 shows a perspective view of the steps of the method for manufacturing an inlay.

FIG. 13 shows a perspective view of the device and the component to be produced.

FIG. 14 shows a section view of an example of the device.

FIG. 15 shows a section view of another example of the device.

FIG. 16 shows a perspective view of the steps of the method for manufacturing an example of the device.

FIG. 17 shows a perspective view of a system of devices and the component to be produced.

FIG. 18 shows a perspective view of an example of the method used to manufacture the supporting structure of the device.

FIGS. 19(a) to 19(f) show different examples of a method for manufacturing a device for a master forming process.

FIGS. 20(a) to 20(c) show an example method for manufacturing a device for a master forming process.

FIGS. 21(a) to 21(c) shows a master forming process.

### DETAILED DESCRIPTION

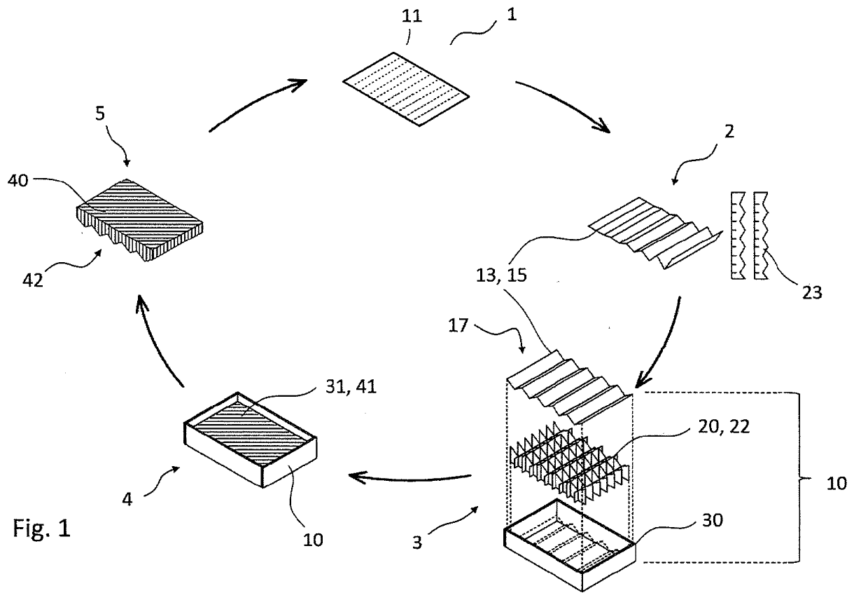

In FIG. 1 an example of the method for manufacturing a device for a master forming process is shown in a first step 1, second step 2 and a third step 3. Further, the master forming process is shown in a subsequent fourth step 4. A fifth step 5 shows the final component to be produced 40.

In the first step 1 a flat initial semi-finished product 11 and data of the geometrical dimensions of a computer model of the component to be produced 40 are provided.

In the second step 2 according to the geometrical dimensions of the computer model of the component to be produced 40 a folding pattern for the flat initial semi-finished product 11 is generated as well as the cutting design for the supporting structure elements 23. The bending process is then carried out giving a three-dimensional structure 13 to the flat initial semi-finished product 11 in order to produce a negative mould 15. Also, the supporting structure elements 23 are cut according to the cutting design.

In the third step 3, the supporting structure 20 is assembled in a grid shape 22 and is then placed in a casing 30 together with the formed three-dimensional negative mould 15. The negative mould 15, the supporting structure 20 and the casing 30 form the assembled device 10 for a master forming process which will be explained via the following step.

In the fourth step 4 the amorphous material 41 is then sprayed or cast onto the one side 17 of the device 10 and/or the negative mould 15 and into the receiving space 31 formed by the casing 30.

In the fifth step 5 the component to be produced 40 with the side bounded and shaped by the negative mould 42 is demoulded and the material of the negative mould 15 is recycled. Now the final component 40 can be scanned and the data of the scanned model can be compared with the computer model in order to adjust the geometry of the next negative mould 15 to be manufactured.

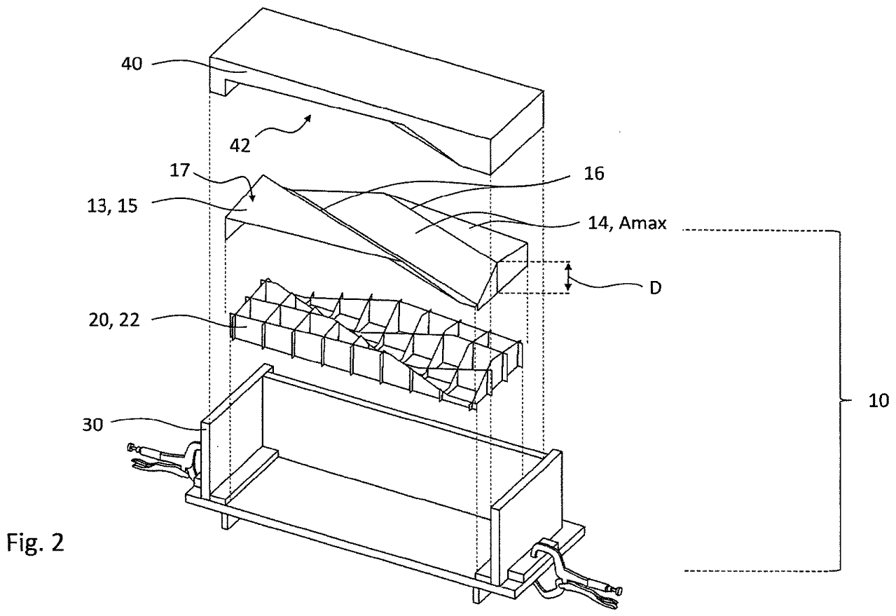

FIG. 2 discloses an example of the device for a master forming process 10 and the component to be produced 40 therewith from a perspective view. The component to be produced 40 is shown at the top with the side bounded and shaped by the negative mould 42 facing the one side 17 of the device 10. The one side bounded and shaped by the negative mould 42 represents the positive shape of the three-dimensional structure 13 of the negative mould 15.

The device 10 comprises the negative mould 15, a supporting structure 20 and a casing 30. In order to form the device 10, the supporting structure 20 forming a grid shape 22 is placed in the casing 30 with the negative mould 15 thereon. The three-dimensional structure 13 of the negative mould 15 is supported by the supporting structure 20, to provide higher bending stiffness. The assembled device 10 can receive various castable or sprayable amorphous materials in order to form the component to be produced 40. In the casting process, the amorphous material is delimited on four sides by the casing 30 and on one side by the three-dimensional structure 13 of the one side 17 of the negative mould 15. The plurality of partial surfaces 14 forming the three-dimensional structure 13 run between two mutually parallel ideal planes.

The three-dimensional structure 13 of the negative mould 15 comprises a plurality of partial surfaces 14 which run between two mutually parallel ideal planes. The ratio between the distance of the planes D and the maximum projection area A max of the negative mould 15 satisfies the condition: A max/D>10 mm. In relation to an extension in the axis of the distance D, the three-dimensional structure 13 has a plurality of local maxima 16.

FIG. 3 shows the supporting structure 20 of the device 10. The supporting structure 20 is manufactured by mechanical connections 21 of supporting structure elements 23 in a grid shape 22. The mechanical connections 21 of the supporting structure elements 23 are realized via plug-in connections. In this case the supporting structure elements 23 are produced with comb joints, allowing them to be easily assembled with 90° angles as it is shown. The supporting structure 20 has a three-dimensional structure 13 on one side to receive the negative mould 15 and to provide higher bending stiffness to it.

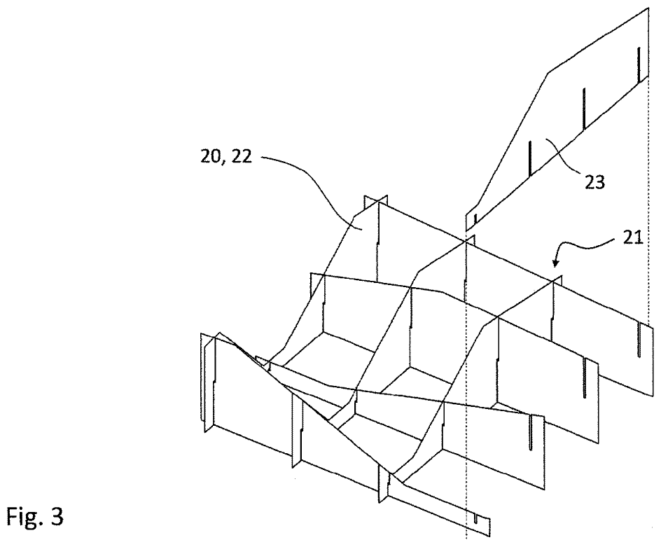

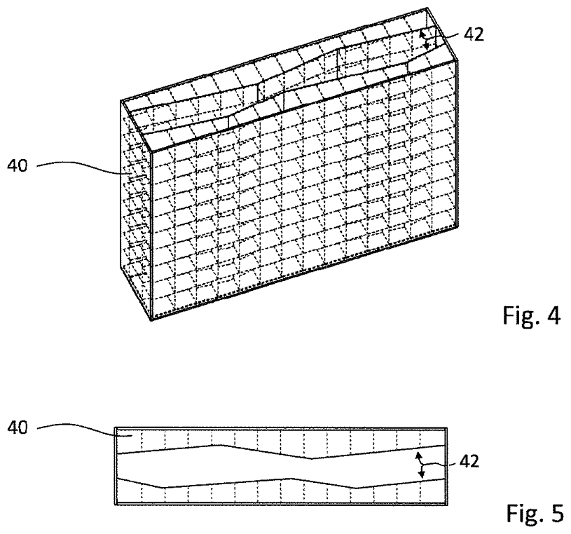

FIG. 4 shows a perspective view of a first example of a component to be produced 40 in the master forming process. It comprises two inner sides bounded and shaped by the negative mould 42. The component represents a hollow wall.

FIG. 5 shows a top view of this first example of a component to be produced 40 in the master forming process. It becomes clear that the component represents a hollow wall.

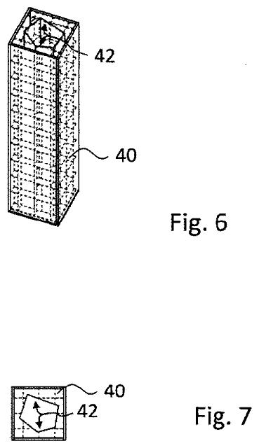

FIG. 6 shows a perspective view of a second example of a component to be produced 40 in the master forming process, and FIG. 7 shows a top view of a second example of a component to be produced 40 in the master forming process. This example also comprises two sides bounded and shaped by the negative mould 42. This component represents a hollow column.

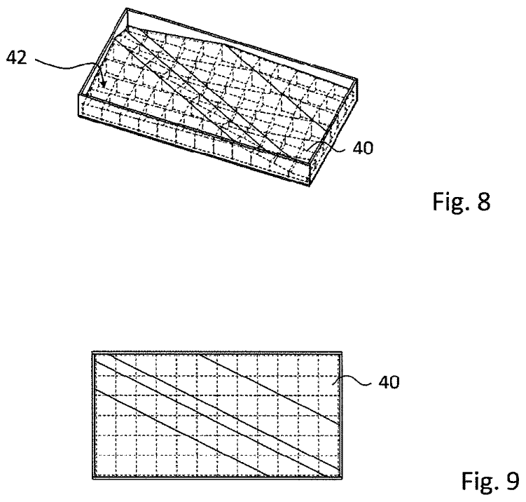

FIG. 8 shows a perspective view of a third example of a component to be produced 40 in the master forming process, and FIG. 9 shows a top view of a third example of a component to be produced 40 in the master forming process. This example comprises one side bounded and shaped by the negative mould 42. This component represents a slab element.

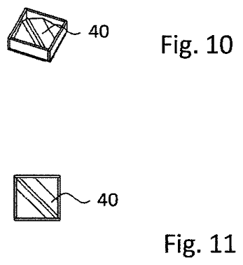

FIG. 10 shows a perspective view of a fourth example of a component to be produced 40 in the master forming process, and FIG. 11 shows a top view of a fourth example of a component to be produced 40 in the master forming process. This example comprises one side bounded and shaped by the negative mould 42. This component represents a tile or façade element.

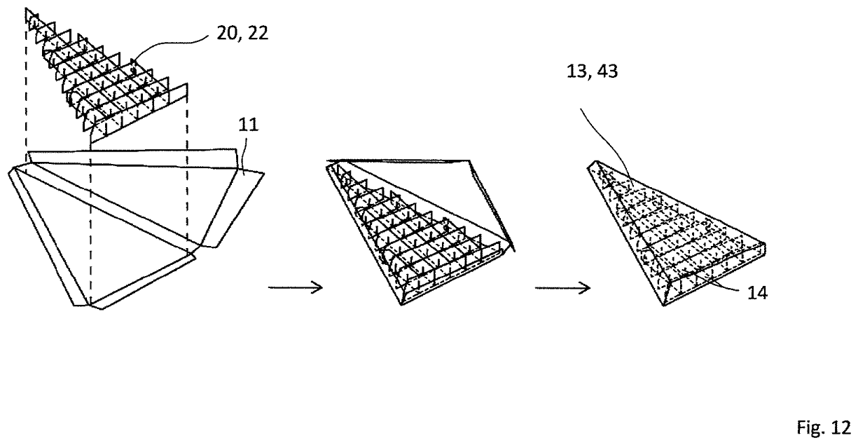

FIG. 12 shows a perspective view of the steps of the method for manufacturing an inlay 43. First, the supporting structure 20 forming a grid shape 22 is placed onto the initial semi-finished-product 11. The initial semi-finished-product 11 is then folded to form an inlay 43 with a three-dimensional structure 13 and a plurality of partial surfaces 14.

FIG. 13 shows a perspective view of device 10 and the component to be produced 40. In order to form the device 10 multiple inlays 43 are placed in the casing 30 to form the negative mould 15. The not occupied space by the negative mould 15 within the casing 30 defines the receiving space 31 in which the amorphous material then is sprayed or cast to form the component to be produced 40 with one side bounded and shaped by the negative mould 42.

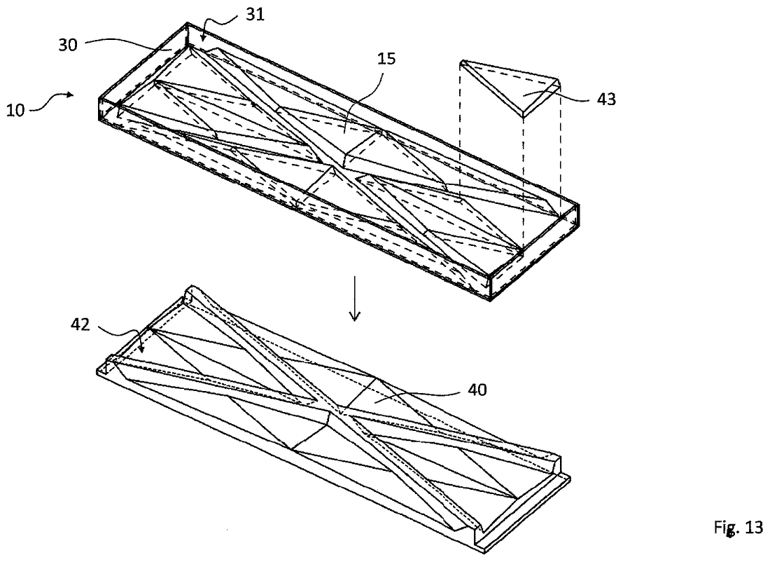

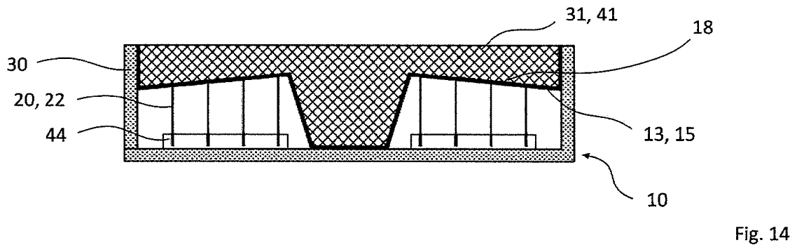

FIG. 14 discloses an example of the device for a master forming process 10 from a section view. In order to form device 10, the supporting structure 20 forming a grid shape 22 is placed in the casing 30 with the negative mould 15 thereon. The three-dimensional structure 13 of the negative mould 15 is supported by the supporting structure 20 to provide higher bending stiffness. To secure the position of the supporting structure 20, the supporting structure is placed onto a placement guide 44 which defines the position of the supporting structure 20 in the casing 30. The leftover space in the casing 30 defines the receiving space 31 in which the amorphous material 41 is sprayed or cast.

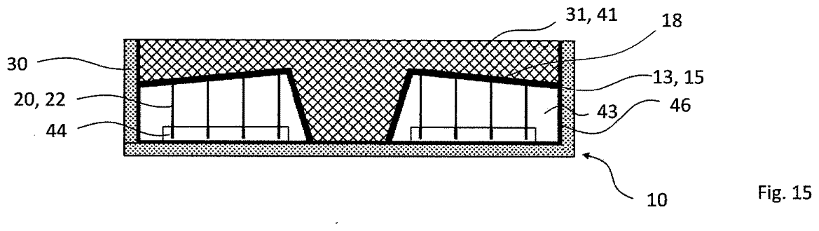

In difference to that, the example of device 10 shown in FIG. 15 has a supporting structure 20 enveloped by a housing of the supporting structure 46. Together the supporting structure 20 and the housing of the supporting structure 46 are forming a respective inlay which is placed in the casing 30 with the negative mould 15 thereon.

In the two examples shown in FIGS. 14 and 15, various coatings can be applied on top of the negative mould forming the three-dimensional structure, for example, coatings with hydrophobic properties such as wax, silicon, polyethylene, anti-adherent spray or liquids.

This coating, also named as hydrophobic inlay 18, can simply be applied to the negative mould. Therefore, no special process is required to delaminate it from the negative mould after use. After concrete casting, it can be removed from the concrete element and recycled.

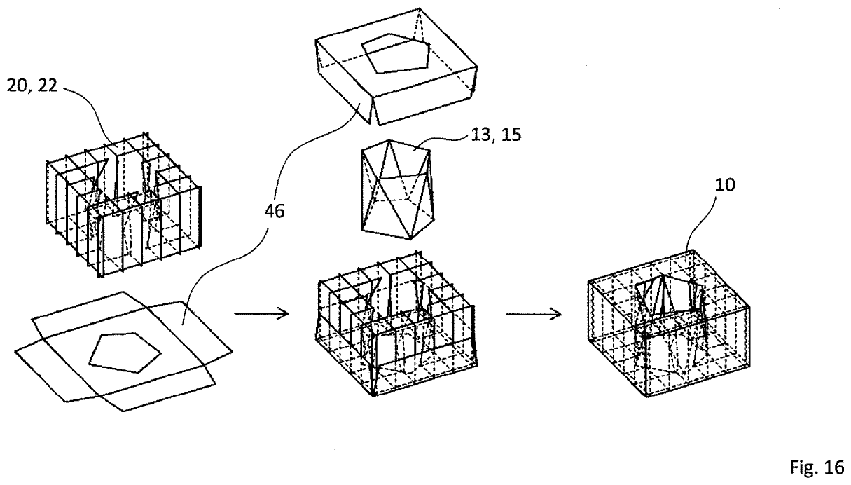

FIG. 16 shows a perspective view of the steps of the method for manufacturing a device 10 according to an example. At first, the supporting structure 20 forming a grid shape 22 is positioned on an element of the housing of the supporting structure 46. The three-dimensional structure 13 of the negative mould 15 then is positioned inside the supporting structure 20 and covered with another element of the housing of the supporting structure 46. The negative mould 15 together with the supporting structure 20 enclosed by the housing of the supporting structure 46 are forming the device 10. The inner side of this device 10 is the side defining the negative mould.

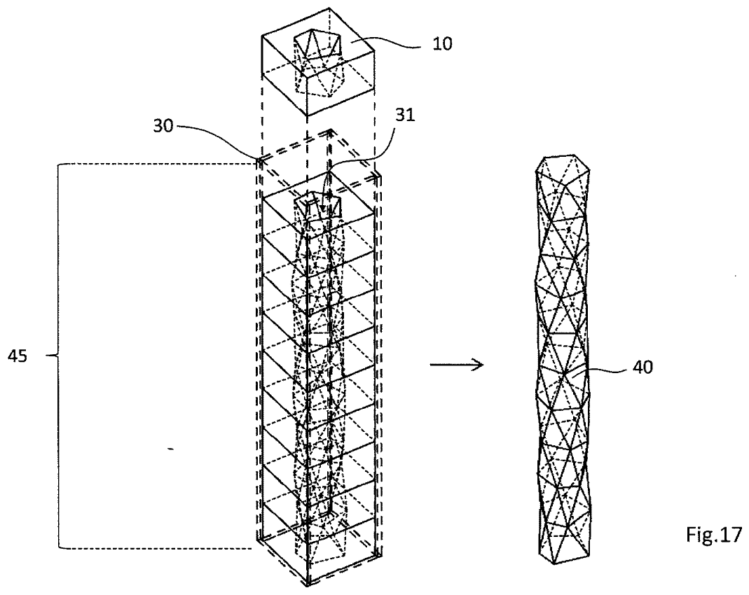

FIG. 17 shows a perspective view of a system of devices 45 and the component to be produced 40 with it. The system of devices 45 is formed by combining multiple devices 10. The devices 10 are positioned on top of each other in such a way that the receiving spaces 31 of the devices 10 adjoin each other and form one big receiving space 31 to receive the amorphous material cast or sprayed inside to form the component to be produced 40. The devices 10 can but don't have to be placed in a casing 30.

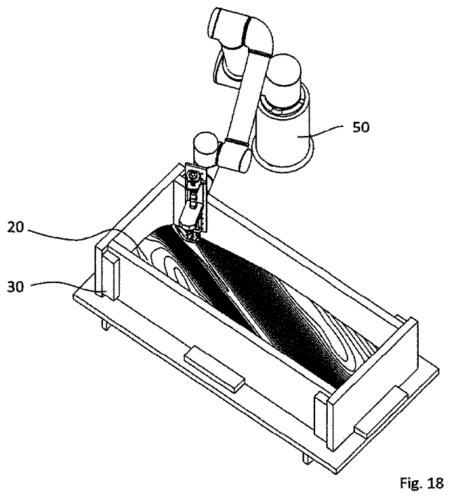

FIG. 18 shows a perspective view of an example of the method used to manufacture the supporting structure 20 of the device. The supporting structure 20 is shaped inside the casing 30 via a CNC-device 50 which is shown above the casing 30.

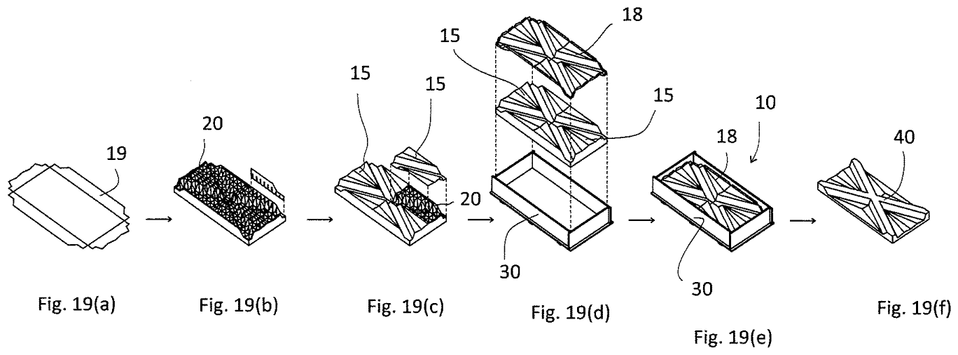

FIGS. 19(a) to 19(f) show a further example of the method for manufacturing a device for a master forming process, comprising steps a) to f). In a step a), a bordering 19 is provided, which can also be a folded or bent material.

In a step b), a supporting structure 20 is assembled by mechanical connections and is placed inside the bordering 19 which is folded in a box-like shape. In a step c), a plurality of negative moulds 15 is placed on top of the supporting structure 20, thereby forming a closed structure.

In step d), a hydrophobic inlay 18 is placed on top of the closed structure provided by the plurality of negative moulds 15.

Thus, a device 10 for a master forming process is provided, as shown in step e). Via this device 10, a component to be produced 40 can be manufactured, as shown in step f).

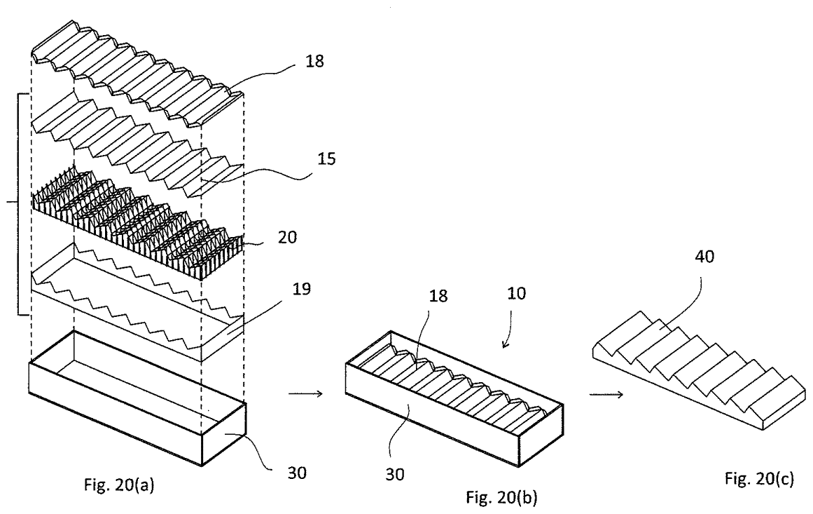

FIGS. 20(a) to 20(c) show another example of the method for manufacturing a device for a master forming process, comprising steps a) to c).

Here, in step a) a bordering 19, a supporting structure 20, a negative mould 15 and a hydrophobic inlay 18 are provided and are arranged on top of one another in the casing 30.

Thus, a device 10 for a master forming process is provided, as shown in step b). Via this device 10, a component to be produced 40 can be manufactured, as shown in step c), which is here a staircase element.

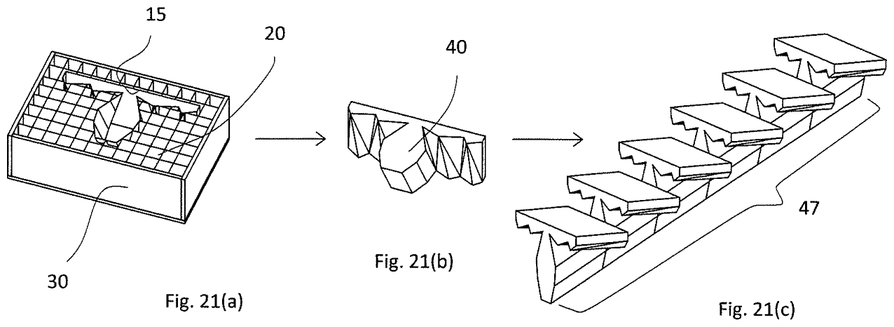

FIGS. 21(a) to 21(c) shows a master forming process, comprising steps a) to c). In step a), a device 10 for a master forming process is provided, comprising inside a casing 30 a supporting structure 20 as well a negative mould 15 defining a space for intake of amorphous material. Step b) shows the component to be produced 40 which is a staircase element. In step c) a plurality of such staircase elements is combined in a system of produced components 47 in form of a staircase.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a device for a master forming process, the method comprising:
providing a flat initial semi-finished product;
deforming the initial semi-finished product in a bending process such that the initial semi-finished product is given a three-dimensional structure as a negative mould on one side via a plurality of partial surfaces running in different planes, the plurality of partial surfaces being configured to delimit a component produced via a master forming process using the device on one side in the master forming process;
providing a supporting structure; and
arranging the negative mould at or on or around the supporting structure such that the negative mould and an amorphous material to be arranged thereon is supported or supportable by the supporting structure in the master forming process,
wherein the initial semi-finished product is bent in such a way that it forms a cavity, and
wherein the supporting structure is provided inside the cavity.

2. The method for manufacturing a device for a master forming process according to claim 1, wherein the initial semi-finished product is folded to realize the plurality of partial surfaces.

3. The method for manufacturing a device for a master forming process according to claim 1, wherein the initial semi-finished product is formed at least partially of paper or cardboard.

4. The method for manufacturing a device for a master forming process according to claim 1, wherein the negative mould with the three-dimensional structure is provided with a hydrophobic insert on at least one side.

5. The method for manufacturing a device for a master forming process according to claim 1, wherein the supporting structure is manufactured by mechanical connections of supporting structure elements in a grid shape.

6. The method for manufacturing a device for a master forming process according to claim 5, wherein the mechanical connections of the supporting structure elements is realized via plug-in connections.

7. The method for manufacturing a device for a master forming process according to claim 1, wherein the geometric dimensions of a computer model of the component to be manufactured are used to realize an at least partially automated bending process for manufacturing the plurality of partial surfaces.

8. A device for a master forming process manufactured according to claim 1.

9. The device for a master forming process according to claim 8, wherein the plurality of partial surfaces forming the three-dimensional structure run between two mutually parallel ideal planes whose distance (D) from one another in relation to a maximum projection surface (A max) of the formed initial semi-finished product satisfies the following ratio: A max/D>10 mm.

10. The device for a master forming process according to claim 8, wherein the three-dimensional structure has a plurality of local maxima.

11. The device for a master forming process according to claim 8, wherein the surface of the three-dimensional structure comprises a non-linear profile in all three spatial planes.

12. The device for a master forming process according to claim 8, wherein the device further comprises a casing which, together with the negative mould, delimits a receiving space for receiving the amorphous material at least in some areas.

13. A process for master forming a component, wherein a device manufactured according to claim 1 is provided, and an amorphous material is applied to or on the negative mould so that a component having a side bounded and shaped by the negative mould and partial surfaces thereof is built up at or on the negative mould, and after solidification of the amorphous material, demoulding of the produced component from the negative mould is carried out.

14. The process for master forming a component according to claim 13, wherein the master forming process is a casting process, a spraying process and/or a coating process.
